(19) United States
(12) Patent Application Publication
(10) Pub. No.: US 2026/0115898 A1
(43) Pub. Date: Apr. 30, 2026

(54) COMPLIANT MECHANISM MICROSPINES FOR MOBILE SOFT ROBOTS

(71) Applicant: The Board of Trustees of The University of Alabama, Tuscaloosa, AL (US)

(72) Inventors: Lauren Ervin, Tuscaloosa, AL (US); Vishesh Vikas, Tuscaloosa, AL (US)

(21) Appl. No.: 19/367,007

(22) Filed: Oct. 23, 2025

Related U.S. Application Data
(60) Provisional application No. 63/711,508, filed on Oct. 24, 2024.
(60) Provisional application No. 63/753,183, filed on Feb. 3, 2025.

(51) Int. Cl. B25J 9/10; B25J 17/00; B29C 64/118; B29K 75/00; B29L 31/30; B33Y 10/00; B33Y 40/00; B33Y 80/00

(52) U.S. Cl. CPC B25J 9/10; B25J 17/00; B29C 64/118; B33Y 10/00; B33Y 40/00; B33Y 80/00; B29K 2075/00; B29K 2995/007; B29L 2031/30

(57) ABSTRACT

A compliant microspine mechanism is configured to be coupled to a soft robot. The compliant microspine mechanism includes a body having a first portion configured to be rigidly coupled to an arm of the soft robot, a second portion having a microspine rigidly secured thereto, and a joint positioned between the first portion and second portion. The joint is configured to allow the second portion to pivot or move relative to the first portion.

### CROSS REFERENCE

This application claims the priority benefit of U.S. Provisional Patent Application No. 63/753,183 filed Feb. 3, 2025 and U.S. Provisional Patent Application No. 63/711,508 filed Oct. 24, 2024, which are hereby incorporated herein by reference in their entireties.

### BACKGROUND

Exploratory robots may be used to explore environments unsafe for humans or perform monitoring tasks. Such robots often take the form of wheeled or aerial vehicles controlled remotely. Often, these exploratory robots have difficult times traversing different types of terrain and materials.

Therefore, there is a need in the art for soft robotic devices which can explore a variety of environments and traverse different types of terrain and materials.

### SUMMARY

Various implementation described herein are related to a compliant microspine mechanism for a soft robot.

In some aspects, the disclosure relates to a compliant microspine mechanism configured to be coupled to a soft robot. The compliant microspine mechanism includes a body having a first portion configured to be rigidly coupled to an arm of the soft robot, a second portion having a microspine rigidly secured thereto, and a joint positioned between the first portion and second portion. The joint is configured to allow the second portion to pivot or move relative to the first portion.

In some aspects, the joint and the second portion of the compliant microspine mechanism are exposed relative to a distal end of the arm of the soft robot.

In some aspects, the first portion of the body defines one or more mounting apertures defined therein. In some aspects, the one or more mounting apertures are configured to receive material poured into a mold to rigidly couple the compliant microspine mechanism to a distal end of the arm.

In some aspects, the second portion defines a receiving cavity sized to receive the microspine.

In some aspects, the body of the compliant microspine mechanism is formed of a single material.

In some aspects, the disclosure relates to a method of manufacturing the compliant microspine mechanism described herein. The method comprises partially printing the body so the receiving cavity for the microspine is partially formed, pausing the printing, inserting the microspine into the receiving cavity, and resuming the printing so the microspine is fixed within the body.

In some aspects, a portion of the compliant microspine mechanism defining the joint is an arcuate segment extending from the first portion to the second portion.

In some aspects, the arcuate segment defining the joint extends above a top edge of the first portion and the second portion.

In some aspects, a recess is formed between the first portion and the second portion such that the first and second portions are only coupled together with the arcuate segment.

In some aspects, the disclosure relates to a soft robot including a base, a plurality of arms coupled to the base, and an actuator coupled to each of the plurality of arms. The actuator is configured to deform each of the plurality of arms between a flat configuration and a curved configuration. The soft robot also includes an array of compliant microspine mechanisms configured to be coupled to each of the plurality of arms. Each compliant microspine mechanism of the array includes a body. The body includes a first portion configured to rigidly coupled to an arm of the soft robot and a second portion having a microspine rigidly secured thereto. The second portion of each compliant microspine mechanism is configured to pivot or move relative to the first portion independently of the other compliant microspine mechanisms in the array.

In some aspects, the soft robot further includes a joint positioned between the first and second portion. In some aspects, the joint is configured to allow the second portion to pivot or move relative to the first portion.

In some aspects, a portion of the compliant microspine mechanism defining the joint is an arcuate segment extending from the first portion to the second portion.

In some aspects, the joint and the second portion of the compliant microspine mechanisms are exposed relative to a distal end of each of the plurality of arms of the soft robot.

In some aspects, the first portion of the body defines one or more mounting apertures defined therein, and wherein the one or more mounting apertures are configured to receive material poured into a mold to rigidly couple the compliant microspine mechanism to a distal end of the arm.

In some aspects, the second portion defines a receiving cavity sized to receive the microspine.

In some aspects, the body of the compliant microspine mechanisms are formed of a single material.

In some aspects, the array of compliant microspine mechanisms includes a first row and a second row arranged in a stacked configuration, wherein each of the compliant microspine mechanisms are configured to passively move independently of each other.

In some aspects, the first row has more compliant microspine mechanisms than the second row.

In some aspects, the disclosure relates to a method of manufacturing a compliant microspine mechanism with a 3D printer. The method include partially printing a body of the compliant microspine mechanism. The body includes a first portion configured to be rigidly coupled to an arm of a soft robot, a second portion having a receiving cavity defined therein, and a joint positioned between the first portion and second portion. The joint is configured to allow the second portion to pivot or move relative to the first portion. The method also includes pausing the printing when the receiving cavity for the microspine is partially formed, inserting a microspine into the receiving cavity, and resuming the printing so the microspine is fixed within the body.

In some aspects, the body of the compliant microspine mechanism is printed with a fused deposition modeling 3D printer using thermoplastic polyurethane. In some aspects, the thermoplastic polyurethane has a shore hardness of 95A.

### BRIEF DESCRIPTION OF DRAWINGS

Various implementations of devices, systems, and methods are explained in even greater detail in the following drawings. The drawings are merely exemplary and certain features may be used singularly or in combination with other features. The drawings are not necessarily drawn to scale.

FIG. 1A is a perspective view of a soft robot according to one implementation of the disclosure.

FIG. 1B is a side view of an arm of the soft robot of FIG. 1A.

FIG. 2A is a side view of the arm of the soft robot of FIG. 1A with an array of compliant microspine mechanism.

FIG. 2B is a bottom view of the arm of the soft robot of FIG. 1A.

FIG. 3 is a perspective view of a compliant microspine mechanism.

FIG. 4 is a partial cross-sectional perspective view of the compliant microspine mechanism of FIG. 3.

FIG. 5 is a top view of a soft robot including an array of the compliant microspine mechanism of FIG. 3.

FIG. 6 is a side perspective view of the array of the compliant microspine mechanism coupled to the arm of the soft robot in a relaxed or flat position.

FIG. 7 is a side perspective view of the array of the compliant microspine mechanism coupled to the arm of the soft robot in a curved or actuated position.

FIG. 8A is a side perspective view of the array of the compliant microspine mechanism gripping a first type of surface.

FIG. 8B is a schematic view illustrating which of the compliant microspine mechanisms of the array grip the first type of surface.

FIG. 9A is a side perspective view of the array of the compliant microspine mechanism gripping a second type of surface.

FIG. 9B is a schematic view illustrating which of the compliant microspine mechanisms of the array grip the second type of surface.

FIG. 10A is a perspective view of a modular mold for making a soft robot having three arms, wherein at least one arm defines receiving channels for receiving an array of the compliant microspine mechanisms shown in FIG. 3.

FIG. 10B is a perspective view of an end portion of the modular mold shown in FIG. 10A.

FIG. 10C is another perspective view of the end portion of the modular mold shown in FIG. 10B with an array of compliant microspine mechanisms.

FIG. 10D is a perspective cross-sectional view of the end portion of the modular mold of FIG. 10A, illustrating the plurality of receiving channels for receiving the array of compliant microspine mechanisms.

FIG. 10E is another perspective view of the end portion of the modular mold of FIG. 10A with the array of compliant microspine mechanisms.

### DETAILED DESCRIPTION

The devices, systems, and methods disclosed herein provide for a compliant microspine mechanism for a soft robot capable of locomotion.

As described herein, integrating microspines into soft robots is an attractive option due to their adaptability and conformability to changing surface topologies. The continuum nature and impact resistance of soft materials passively allow soft robots additional flexibility and more effective interaction with complex and non-uniform surfaces. However, soft robots lack grip stability, historically struggling with efficient locomotion as well as locomoting over un-structured terrain. Because of this, soft robots designs that can traverse outside and perform real tasks outside of a lab setting are under-researched. Utilizing microspines has the potential to improve traction, increase grip stability, and provide the ability to reliably maneuver real-world terrains. One of the main design challenges pertain to integrating a soft body (low stiffness) with hard microspines (high stiffness).

A two segment, wriggling soft robot avoids this challenge by adhering an array of dual material, “soft microspines” made of rubber along the ventral of the body to successfully increase anisotropic friction. A starfish inspired soft robot implements a similar technique by including soft, tube feet reminiscent of microspines along the entire underside of the five-limbed robot. Magnetization of the tube feet allows omnidirectional movement and reduces the motion resistance from the ground, enhancing the adaptability of the soft robot on different surfaces. Embedding hard objects in soft materials through intelligent mechanical design is necessary to take advantage of the benefits of hard spines without hindering the soft deformable properties. A soft inchworm design attaches an array of microspines to either foot of the inchworm using adhesive bonding technology. However, deeply irregular surfaces remain difficult if not impossible to overcome due to the uniform distribution of the microspines and integration technique that restricts the usage to surfaces with regular, fine asperities. This shows the need for compliance and independent movement per microspine to increase surface geometry traversability.

The disclosure below bridges the realization gap by attaching microspine technology onto the tips of soft motor tendon actuated (MTA) limbs or arms, vastly improving the grip stability and types of traversable terrain of mobile soft robots.

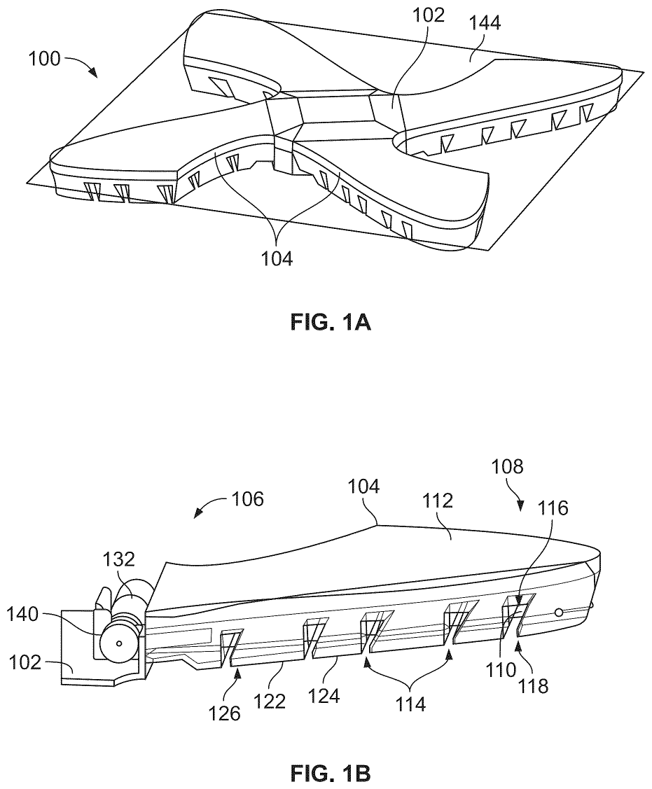

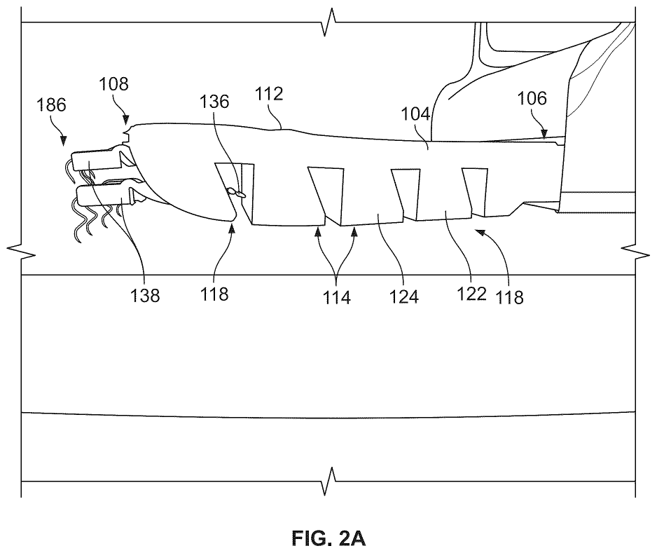

FIGS. 1A-2B illustrate a soft robot 100 according to an implementation. The soft robot 100 includes a base 102, at least one limb or arm 104, and at least one actuator 132 (FIG. 1B). FIGS. 2A-2B show various elements of the modular soft robot 100 in further detail.

Now with reference to FIG. 1A, each arm 104 includes a first arm end 106 coupled to the base 102 and a second arm end 108 separated from the first arm end 106 in a direction away from the base 102. A central plane 144 extends through the robot 100 and bisects the base 102 and the arm(s) 104. In other words, each arm 104 is coupled to the base 102 such that each arm 104 is longitudinally bisected by the central plane 144.

The robot 100 includes four arms 104 coupled to the base 102. A central axis of each arm extends between the first arm end 106 and the second arm end 108. Each arm 104, and the corresponding axis of each arm 104, equally spaced around the base 102. For example, robot 100 of FIG. 1A having 4 arms 104 are each spaced apart 90° from each other. However, in some implementations, the arms are not spaced equally apart from each other (e.g., 3 arms may be placed close to each other, separated by 60°, while one arm may be further apart, separated by 120° from two of the arms).

Now with reference to FIG. 1B, each arm 104 of the robot 100 includes a first surface 110 and a second surface 112 opposite and spaced apart from the first surface 110. The first surface 110 defines a plurality of channels 114. Each channel 114 includes a proximal end 116 at the first surface 110 and a distal end 118 spaced apart from the proximal end 116. Each channel 114 has a longitudinal axis extending therethrough.

Each of the channels 114 is further defined by two adjacent protrusions. For example, in FIG. 1B, two of the protrusions are labeled 122 and 124. The first protrusion 122 and the second protrusion 124 extend from the first surface 110 of the arm 104. The protrusions 122, 124 each have an end surface 126 separated and spaced apart from the first surface 110. In some implementations, the protrusions are integrally formed with the first surface 110 of the arm.

Now with reference to FIG. 1B, the actuator 132 is a motor coupled to a spool 134. A mount 140 (FIG. 1B) of the base 102 removably couples the motor 132 and the spool 134 to the interior of the base 102. The spool 134 is coupled to a tendon 136 (FIGS. 2A, 2B). The tendon 136 is operably coupled to the arm 104 by a hook 137 (FIG. 2B). In the illustrated implementation, the hook is a single multi-pronged fishing hook that secures the tendon 136 to the second arm end 108.

The robot 100 includes four actuators 132 corresponding to the four arms 104. The tendon 136 of each actuator 132 extends through the base 102 and into the corresponding arm 104. The tendon 136 extends through several channels 114 of the arm 104. When the motor 132 actuates and the tendon 136 is tightened around the spool 134 to move the arms 104. In the implementations shown, the tendon is a wire. In other implementations, the actuator is a spring, a shape memory alloy, or any other mechanism for extending and retracting a member. As described in more detail below, one or more compliant microspine mechanism(s) 138 are rigidly secured to the second arm end 108 of the arm 104 and passively interact with the environment during movement of the arms 104.

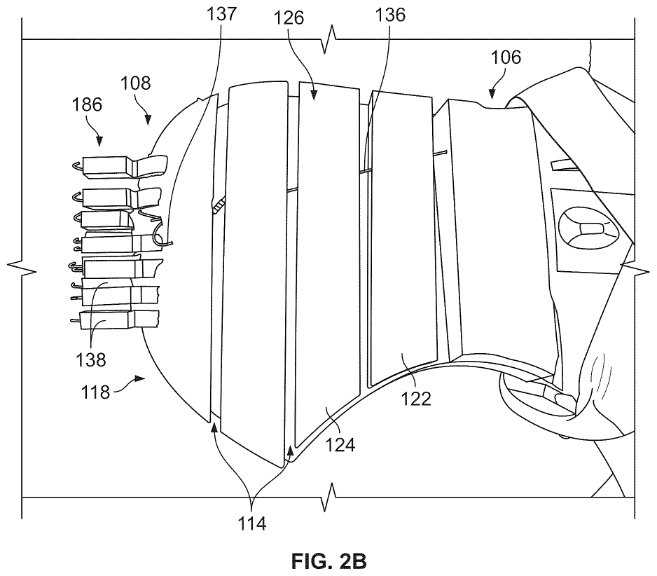

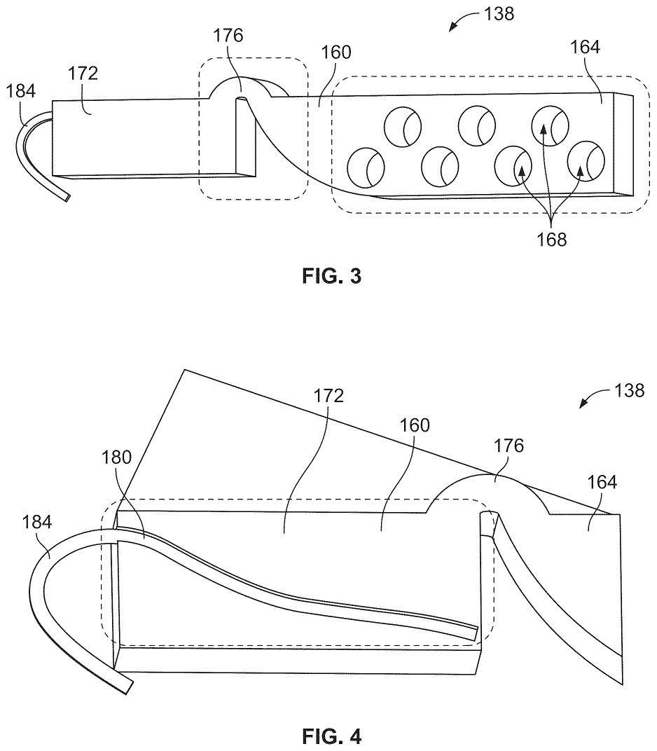

Now with reference to FIGS. 3 and 4, the compliant microspine mechanism 138 is illustrated in detail. The compliant microspine mechanism 138 includes a body 160 having a first portion 164 defining one or more mounting apertures 168, a second portion 172, and a joint 176 positioned between the first and second portions 164, 172. The first portion 164 is coupled to the arm 104 (FIG. 2A) of the soft robot 100. In the illustrated implementation, the first portion 164 has seven apertures 168 defined therein for attaching the body 160 to the arm 104. In other implementations, the first portion 164 may include more (e.g., eight, nine, etc.) or less (e.g., six, five, etc.) mounting apertures 168. As described in more detail below, the mounting apertures 168 are configured to receive material (e.g., silicone rubber) during a molding process to rigidly attach the first portion 164 of the body 160 to the second arm end 108.

The second portion 172 defines a receiving cavity 180 sized to receive a hook or microspine 184. The receiving cavity 180 rigidly supports the microspine 184 (FIG. 4) relative to the second portion 172. In the illustrated implementation, the receiving cavity 180 has a curved geometry and extends across all of or a majority of the second portion 172. In other implementations, the microspine 184 may be rigidly secured to the second portion 172 in an alternative fashion. The angle of the microspine 184 relative to an end of the second portion 172 can be modified for different surface topologies while the microspine 184 remains secured in the body 160. In the illustrated implementation, the angle of the microspine 184 is fixed at approximately 45′. In other implementations, the angle of microspine 184 may be adjusted.

The joint 176 allows pivoting and movement (compliance) between the first and second portions 164, 172. As described in more detail below, the joint 176 and the second portion 172 of the compliant microspine mechanism 138 are exposed relative to a distal end of the arm 104 of the robot 100. Exposing the second portion 172 and the joint 176 allows for the movement of the second portion 172 relative to the first portion 164 of the compliant microspine mechanism 138. Further, the portion of the compliant microspine mechanism 138 defining the joint 176 is an arcuate segment extending from the first portion 164 to the second portion 172 (FIGS. 3 and 4). In the illustrated implementation, the arcuate segment defining the joint 176 extends above a top edge of the first portion 164 and the second portion 172. The compliant microspine mechanism 138 further comprises a recess formed between the first portion 164 and the second portion 172 such that the first and second portions 164, 172 are only coupled together with the arcuate segment.

In some implementations, the body 160 of the compliant microspine mechanism 138 is formed of a single material to allow compliance in the joint 176 while simplifying the fabrication process over previous microspine designs. In some implementations, the body 160 of the compliant microspine mechanism 138 may be fabricated with a fused deposition modeling (FDM) 3D printer using thermoplastic polyurethane (TPU). The TPU may have a shore hardness of 95A. During assembly of the compliant microspine mechanism 138 using the 3D printer in an additive manufacturing process, the body 160 may be partially printed (e.g., as shown with the cross-sectional view in FIG. 4). Once the receiving cavity 180 is partially formed, the printing may be paused and the microspine 184 is inserted into the receiving cavity 180. The print is resumed, and once the print is finished, the microspine 184 is fixed within the body 160. In other implementations, the microspine 184 may be rigidly coupled to the second portion 172 of the body 160 using shape deposition manufacturing.

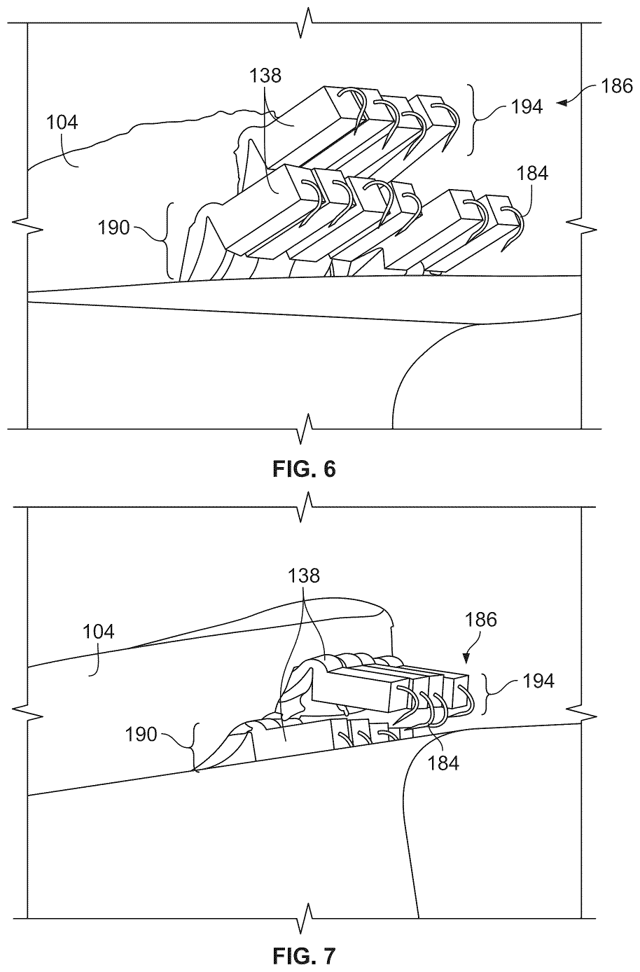

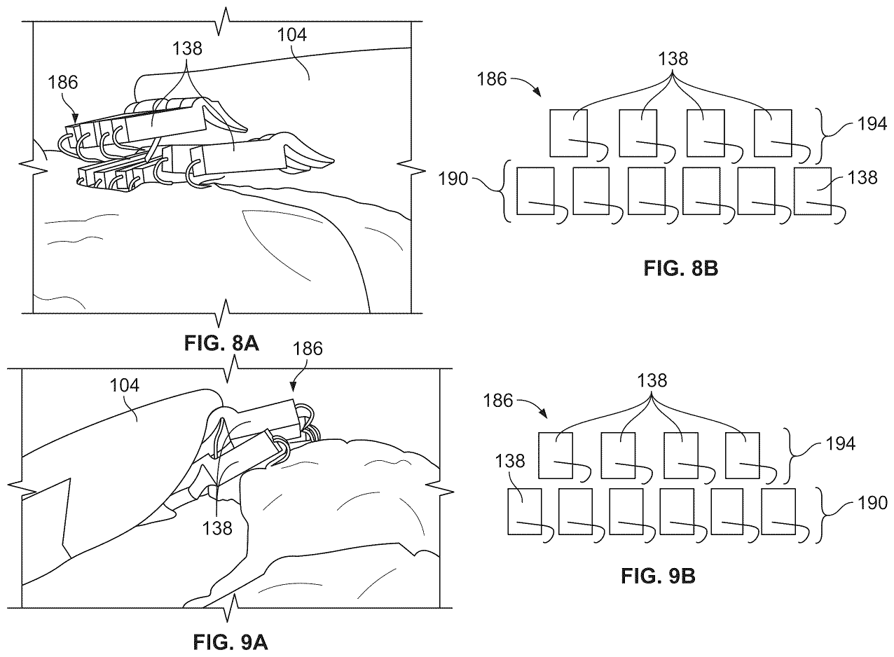

In use, the actuator 132 is configured to deform the arm 104 between a flat configuration and a curved configuration by releasing or retracting the tendon 136, respectively. In the flat configuration, the tendon 136 is in a neutral or extended position. In the curved configuration, the tendon 136 is in a retracted position. When the tendon 136 is retracted, the second end 108 of the arm 104 is closer to the first end of the arm 104, which changes the angle of microspine 184 and the second portion 172 of each compliant microspine mechanism 138 relative to the surface on which arm 104 is disposed. FIGS. 2A and 6 show the compliant microspine mechanism(s) 138 in a flat position, and FIG. 7 shows the compliant microspine mechanism in a curved position.

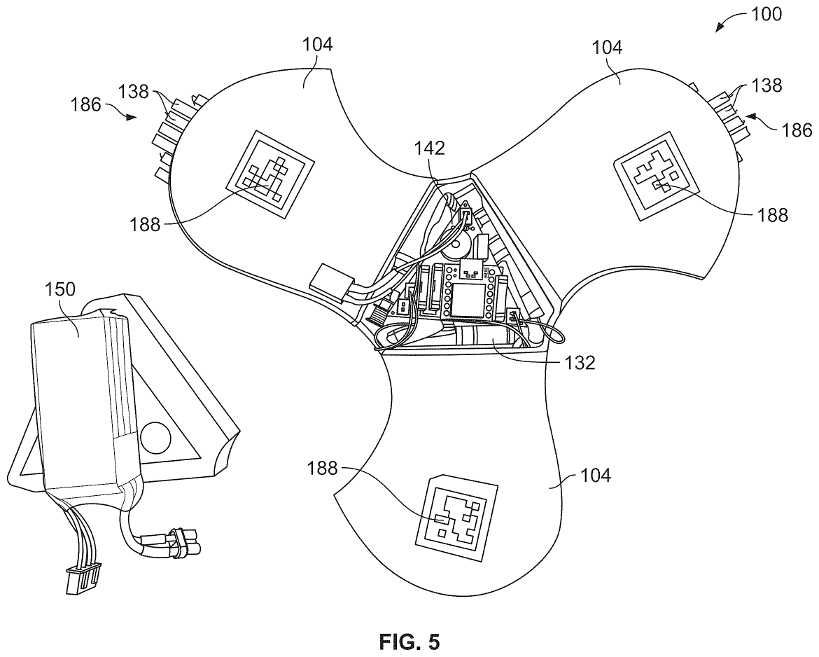

As shown in FIG. 5, a circuit board 142 is disposed within the base 102, and the circuit board 142 is in electrical communication with the motor 132 (FIG. 1B) via I/O interfaces (not shown) available on the circuit board 142. A battery 150 is in electrical communication to one or both of the circuit board 142 and the motor(s) 132 to provide power. A power and battery interface (not shown) may be included on the circuit board 142 for power control circuitry.

To move the arm 104 into the curved configuration, the circuit board 142 may include memory storing robot movement software, that upon execution, directs the motor 132 to turn the spool 134 associated with the arm 104, which transforms the rotational motion into linear motion by retracting a portion of the tendon 136 of the arm 104. The tendon 136 facilitates transmission of force across the arm 104.

In the flat configuration, each channel 114 has a first width at the distal end 118 of the channel 114. The soft materials of the arm 104 allow for the change in width of the distal end 118 of the channel 114 and generally allow for the curved orientation of the arm 104 in the curved configuration. Each arm 104 is composed of silicone rubber. In other implementations, the arms are made from a different soft, deformation silicone or plastic material enabling the described deformation.

In the curved configuration, each channel 114 has a second width at the distal end 118 of the channel 114, wherein the first width is greater than the second width. Thus, the soft material (e.g., silicone rubber) of the arm 104 deforms into a contoured or curved shape (as opposed to the flat shape of the flat configuration). Said another way, the flat configuration of the robot 100 and arm 104 has zero curvature while the curved configuration has positive curvature.

Now with reference to FIG. 5, an implementation of the soft robot 100 illustrated. One or more of the arms 104 of the soft robot 100 include an array 186 of the compliant microspine mechanisms 138. When integrated into the arms 104 of the robot 100, the array 186 of the compliant microspine mechanisms 138 can provide the ability to maneuver uneven terrains, traverse inclines, and even climb walls. In some implementations, fiducial markers 188 (e.g., such as AprilTags™) may be coupled to the arms 104 of the soft robot 100. The fiducial markers 188 may be used to detect the position of the soft robot 100 (e.g., for the experiment described below).

Conformability and adaptability of the soft robot 100 makes them ideal candidates for these applications involving traversal of complex, unstructured terrains. The implementation described herein includes a stacked array 186 of the passive, compliant microspine mechanisms 138 to enhance the locomotion capabilities of the soft robot 100 (e.g., incorporated in a motor tendon actuated soft robot). The array 186 described herein has an effective soft-compliant stiffness integration and reduced complexity resulting from the actuator 132 passively controlling the array 186.

Now with reference to FIGS. 6 and 7, an implementation of the array 186 of the compliant microspine mechanisms 138 is illustrated. In the illustrated implementation, the array 186 includes two rows of the compliant microspine mechanisms 138 arranged in a stacked configuration. In other implementation, the array 186 may include more rows (e.g., three, four, etc.) Further, the illustrated implementation includes six compliant microspine mechanisms 138 in a first row 190 and four compliant microspine mechanisms 138 in a second row 194. In other words, the first row 190 has more compliant microspine mechanisms 138 than the second row 194. In other implementations, the first and second rows 190, 194 may have more or less compliant microspine mechanisms 138.

Each compliant microspine mechanism 138 is operably coupled to arm 104 and are independently movable between a flat position (shown in FIG. 6) and a curved position (shown in FIG. 7). Further, the construction of each compliant microspine mechanism 138 allows the compliant microspine mechanisms 138 to passively move independently of each other. The configuration of the array 186 offers additional gripping capabilities on extremely steep/irregular surfaces from the top row while not hindering the effectiveness of the more frequently active bottom row. Different configurations of the array 186 are contemplated to account for changing surface topologies and enable independent, adaptable gripping of asperities per microspine.

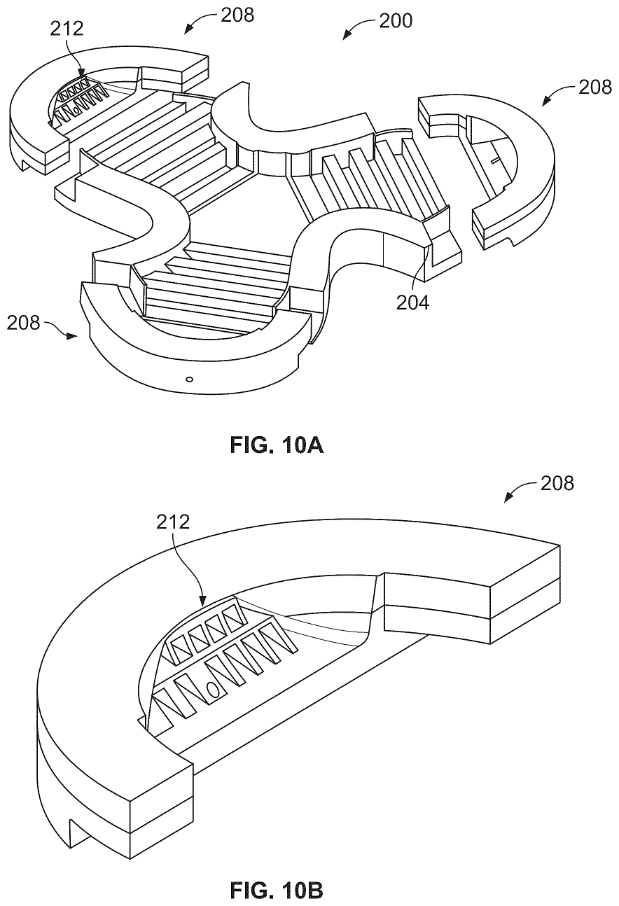

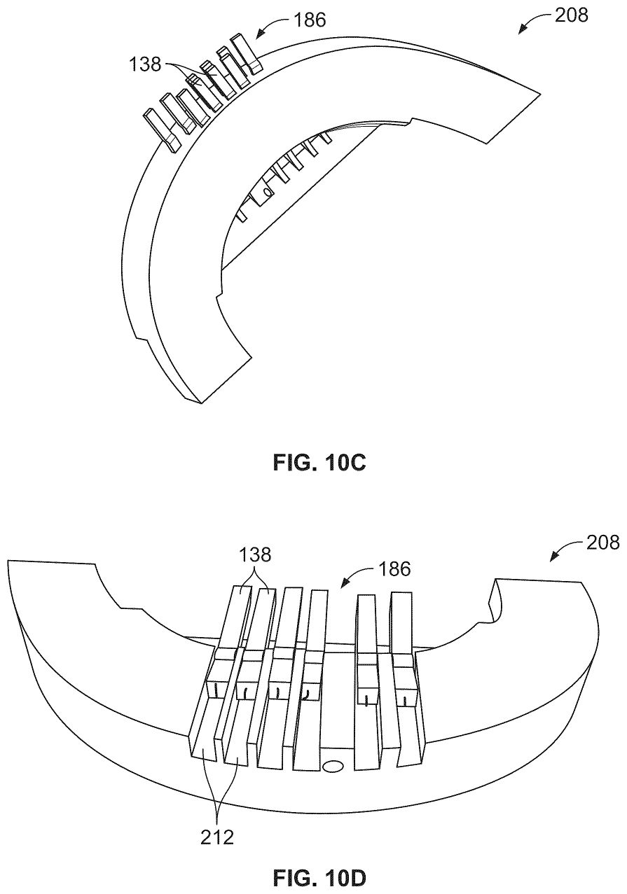

FIGS. 8A-9B illustrate which compliant microspine mechanism 138 of the array 186 engages a surface when the robot 100 traverses across different surfaces. The compliant microspine mechanisms 138 in the first row 190 are commonly active on more uniform terrain. The second row 194 can become active on steep/highly irregular surfaces without hindering the movement of the first row 190 of the compliant microspine mechanisms 138. The critical parameter when designing the array 186 configuration is ensuring adequate surface interaction and gripping regardless of topology. Not all of the compliant microspine mechanisms 138 need to interact with a surface for the array 186 to be effective, which is a byproduct of the passive nature and built-in redundancy of the system.

For example, FIGS. 8A and 8B illustrates the array 186 interacting with a first surface (e.g., a relatively flat rock) while FIGS. 9A and 9B illustrates the array 186 interacting with a second surface (e.g., a relatively steep or inclined rock). In both FIGS. 8B and 9B, the compliant microspine mechanisms 138 that engage with the surface are colored green while the compliant microspine mechanisms 138 that do not engage with the surface are colored red. On the first surface, each of the compliant microspine mechanisms 138 in the first row 190 of the array 186 engage with the first surface, while none of the compliant microspine mechanisms 138 in the second row 194 of the array 186 engage with the surface. On the second surface, two of the compliant microspine mechanisms 138 in the first row 190 of the array 186 engage with the second surface, while three of the compliant microspine mechanisms 138 in the second row 194 of the array 186 engage with the second surface. While two scenarios of the engagement between the compliant microspine mechanisms 138 of the array 186 and a surface are described in detail, it should be appreciated that different combinations of compliant microspine mechanisms 138 may engage the surface depending on the topology of the surface the robot 100 is traversing.

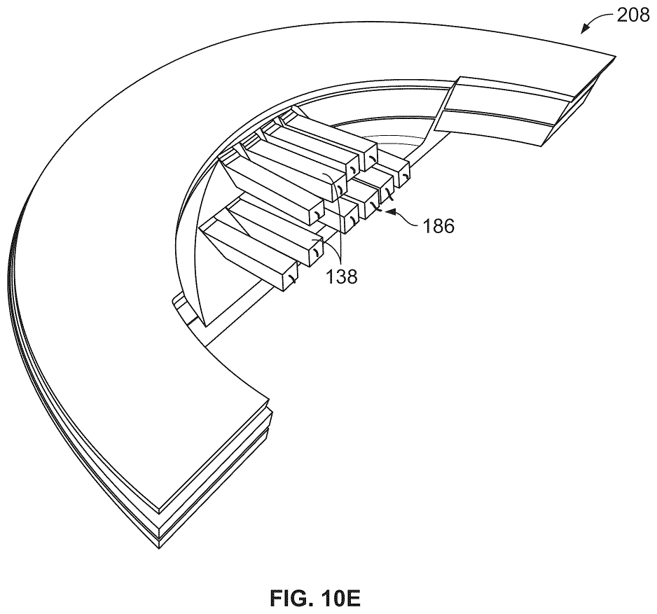

Now with reference to FIGS. 10A-10E, the modular mold 200B includes a main body 204 and a plurality of arm end portions 208 selectively coupled to the main body 204. Each of the arm end portions 208 defines receiving channels 212 that each receive a compliant microspine mechanism 138 and hold the compliant microspine mechanism 138 during the pouring and curing process for forming the soft robot 100. The mold 200B may include multiple arm end portions 208 that each define a different number and/or arrangement of receiving channels 212. The arm end portions 208 may be selectively coupled to the main body 204 for forming soft robots with arms having arrays of compliant microspine mechanisms 138 adapted for traversing different types of surfaces.

In some implementations, the arm end portions 208 and the body 204 may be fabricated with a fused deposition modeling (FDM) 3D printer. During manufacturing of the arm end portions 208 using an additive manufacturing process, the arm end portions 208 may be partially printed (e.g., as shown with the cross-sectional view in FIG. 10D). Once the receiving channels 212 are partially formed, the printing may be paused and the compliant microspine mechanisms 138 are inserted into the receiving channels 212. The print is resumed and once the print is finished, the compliant microspine mechanisms 138 are fixed within the arm end portions 208. As mentioned above, the modularity of the arm end portions 208 allows an operator to change the format of the array 186 of the compliant microspine mechanisms 138 for different applications. The arm end portions 208 are coupled to the body 204, and the material for the arms 104 and base 102 is poured into the mold and allowed to set (e.g., in a cast molding process). In the illustrated implementation, the material poured into the mold is configured to enter the mounting apertures 168 (FIG. 3) to rigidly couple the microspine mechanisms 138 to the arm end portions 208. In alternative implementations, the printing may be completed without pausing, and the compliant microspine mechanisms 138 may be inserted into the receiving channels 212 via end openings of the channels 212.

Although the figures show a specific order of method steps, the order of the steps may differ from what is depicted. It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A compliant microspine mechanism configured to be coupled to a soft robot, the compliant microspine mechanism including a body comprising:
a first portion configured to be rigidly coupled to an arm of the soft robot;
a second portion having a microspine rigidly secured thereto; and
a joint positioned between the first portion and second portion, the joint configured to allow the second portion to pivot or move relative to the first portion.

2. The compliant microspine mechanism of claim 1, wherein the joint and the second portion of the compliant microspine mechanism are exposed relative to a distal end of the arm of the soft robot.

3. The compliant microspine mechanism of claim 1, wherein the first portion of the body defines one or more mounting apertures defined therein, and wherein the one or more mounting apertures are configured to receive material poured into a mold to rigidly couple the compliant microspine mechanism to a distal end of the arm.

4. The compliant microspine mechanism of claim 1, wherein the second portion defines a receiving cavity sized to receive the microspine.

5. The compliant microspine mechanism of claim 4, wherein the body of the compliant microspine mechanism is formed of a single material.

6. A method of manufacturing the compliant microspine mechanism of claim 5, comprising:
partially printing the body so the receiving cavity for the microspine is partially formed, pausing the printing,
inserting the microspine into the receiving cavity, and
resuming the printing so the microspine is fixed within the body.

7. The compliant microspine mechanism of claim 1, wherein a portion of the compliant microspine mechanism defining the joint is an arcuate segment extending from the first portion to the second portion.

8. The compliant microspine mechanism of claim 7, wherein the arcuate segment defining the joint extends above a top edge of the first portion and the second portion.

9. The compliant microspine mechanism of claim 8, wherein a recess is formed between the first portion and the second portion such that the first and second portions are only coupled together with the arcuate segment.

10. A soft robot comprising:
a base;
a plurality of arms coupled to the base;
an actuator coupled to each of the plurality of arms, the actuator configured to deform each of the plurality of arms between a flat configuration and a curved configuration; and
an array of compliant microspine mechanisms configured to be coupled to each of the plurality of arms, wherein each compliant microspine mechanism of the array includes a body comprising:
a first portion configured to rigidly coupled to an arm of the soft robot, and
a second portion having a microspine rigidly secured thereto, wherein the second portion of each compliant microspine mechanism is configured to pivot or move relative to the first portion independently of the other compliant microspine mechanisms in the array.

11. The soft robot of claim 10, further comprising a joint positioned between the first and second portion, wherein the joint is configured to allow the second portion to pivot or move relative to the first portion.

12. The soft robot of claim 11, wherein a portion of the compliant microspine mechanism defining the joint is an arcuate segment extending from the first portion to the second portion.

13. The soft robot of claim 11, wherein the joint and the second portion of the compliant microspine mechanisms are exposed relative to a distal end of each of the plurality of arms of the soft robot.

14. The soft robot of claim 10, wherein the first portion of the body defines one or more mounting apertures defined therein, and wherein the one or more mounting apertures are configured to receive material poured into a mold to rigidly couple the compliant microspine mechanism to a distal end of the arm.

15. The soft robot of claim 10, wherein the second portion defines a receiving cavity sized to receive the microspine.

16. The soft robot of claim 15, wherein the body of the compliant microspine mechanisms are formed of a single material.

17. The soft robot of claim 10, wherein the array of compliant microspine mechanisms includes a first row and a second row arranged in a stacked configuration, wherein each of the compliant microspine mechanisms are configured to passively move independently of each other.

18. The soft robot of claim 17, wherein the first row has more compliant microspine mechanisms than the second row.

19. A method of manufacturing a compliant microspine mechanism with a 3D printer, the method comprising:
partially printing a body of the compliant microspine mechanism, the body comprising a first portion configured to be rigidly coupled to an arm of a soft robot, a second portion having a receiving cavity defined therein, and a joint positioned between the first portion and second portion, wherein the joint is configured to allow the second portion to pivot or move relative to the first portion;
pausing the printing when the receiving cavity for the microspine is partially formed;
inserting a microspine into the receiving cavity; and
resuming the printing so the microspine is fixed within the body.

20. The method of claim 19, wherein the body of the compliant microspine mechanism is printed with a fused deposition modeling 3D printer using thermoplastic polyurethane, and wherein thermoplastic polyurethane has a shore hardness of 95A.
